(19) United States
(12) Patent Application Publication
(10) Pub. No.: US 2015/0295913 A1
(43) Pub. Date: Oct. 15, 2015

(54) ENHANCED SERVER/CLIENT LOGIN MODEL

(71) Applicant: THOMSON LICENSING, Issy Les Moulineaux (FR)

(72) Inventors: Evan Michael Foote, Carmel, IN (US); Mark Anthony Mayhew, Indianapolis, IN (US); Benjamin Thomas Vondersaar, Indianapolis, IN (US)

(21) Appl. No.: 14/440,129

(22) PCT Filed: Nov. 14, 2012
(86) PCT No.: PCT/US12/65079

§ 371 Date: May 1, 2015

(51) Int. Cl. H04L 29/06; H04L 29/08

(52) U.S. Cl. CPC H04L 63/083; H04L 67/10

(57) ABSTRACT

A method for enhanced login is described including determining if a user is attempting to login to a particular account, performing analysis on the user's passwords if the user is not attempting to login to the particular account, determining if it is time to change a password on the particular account, if the user is attempting to login to the particular account, suggesting alternative passwords to the user based on the password analysis and performing a login procedure.

### FIELD OF THE INVENTION

The present invention relates to password use to protect various user accounts, and in particular to a service in a server to obtain and discern passwords to better protect user accounts.

### BACKGROUND OF THE INVENTION

Conventionally, most systems remember the user's previous N passwords, in order to have the user create a different password. This only keeps a history of that account, not from the person.

### SUMMARY OF THE INVENTION

The present invention provides for a service to obtain and discern a user's likely passwords. One password likely has no information on its own. Several passwords put together may contain small bits of information about a user, such as hobbies or interests (especially if passwords are key words or phrases, or are somehow related to each other).

A method for enhanced login is described including determining if a user is attempting to login to a particular account, performing analysis on the user's passwords if the user is not attempting to login to the particular account, determining is it is time to change a password on the particular account, if the user is attempting to login to the particular account, suggesting alternative passwords to the user based on the password analysis and performing a login procedure.

### BRIEF DESCRIPTION OF THE DRAWINGS

The present invention is best understood from the following detailed description when read in conjunction with the accompanying drawings. The drawings include the following figures briefly described below:

FIG. 1 is an overview flowchart of operation of a server in accordance with the principles of the present invention.

FIG. 2 is a flowchart of an exemplary login routine at the server in accordance with the principles of the present invention.

FIG. 3 is a flowchart of an exemplary password analysis routine at the server in accordance with the principles of the present invention.

### DETAILED DESCRIPTION OF THE PREFERRED EMBODIMENTS

The present invention provides for a service to obtain and discern a user's likely passwords. A single password likely has no information on its own. Several passwords put together may contain small bits of information about a user, such as hobbies or interests especially if passwords are keywords or phrases, or are somehow related to each other.

Passwords may also give information about a user's technical competence, such as their security practices (length of passwords, similarities, use of common “dictionary” words). A set of passwords may also give a mask of common characteristics, such as always capitalizing the third letter or always putting a punctuation at the beginning, or different words of varying lengths users may commonly modify (e.g., password must be 6 characters long, user always has “ball” and two special characters. Password must be 8 characters long, user always has “tennis” and two special characters. Password must be 12 characters long, user always has “tennis” and “ball”, with two special characters.)

Once a service knows its user's likely passwords, it can do several things. First, it can determine if the user is using hobbies and interests to formulate their password, and market products towards the user. If the user is technically incompetent (i.e. passwords are matched against other very common passwords), it can guide the user as to how to pick a better password. If the user has a set of common characteristics between their passwords, the service can make recommendations to help the user diversify their passwords.

Also, as a consequence of the present invention, an account becomes more secure from a brute force attack. The owner of the account is likely to re-enter their password, where a brute force attempt will continue, and ignore the “wrong” password.

The present invention provides a method to obtain likely passwords a person has with other profiles or accounts (for instance, email accounts or logins unrelated to the current service.)

The present invention also can help to protect from brute force attacks on inactive accounts, by doubling the amount of time required to log in to an account.

When a user forgets their password for a particular service/account, before resetting their password they are likely to volunteer their “best guess” as to what their password might be, based on similar patterns they use for other accounts. Understanding this behavior, a service can trigger that behavior if the service detects the user is guessing their password. The service will then automatically tell the user they are using the wrong password on their first try. The user may then volunteer their other “best guesses” in order to gain access to their account. If the first password was actually correct, and the user later enters that password, they will have access to their account. The user will then likely blame the lock out on a typo, and will have provided their other passwords.

These password guesses can be stored for later, and can be used to generate a profile of a user's interests, a user's technical or security competence, a user's password pattern, or even help suggest a new password (which passwords not to use) in the event a password expires. Password information can also be used to help train a user to be more secure.

In order for the server to determine if the user can login, several steps must be taken. The first step, the most obvious, is if the password the user enters is correct or not. If the user enters the incorrect password, the user cannot log in. The server then records the details of the login attempt (e.g. account, time, password used). The server then checks the number of incorrect attempts, and if the number is greater than a threshold, locks the account for a time period. If the threshold has not been reached, the server then allows the user to try logging in again.

If the user enters the correct password, several decisions have to be made. If the user has logged into their account recently, or if the user auto filled the field (time password was entered was near zero, as if the password was stored in the browser, as well as a perfect match on the first attempt), the server is more likely to allow the user to log in directly.

If the user had not logged in recently, and the field was not auto filled, the server is more likely to tell the user that they are not allowed to log in. If the server tells the user it cannot log in even though the account details are correct, the threshold for number of log in attempts is increased. If the user enters the correct password again (twice in a row), the user is automatically allowed access.

During server idle time, the server can then examine passwords a user supplied incorrectly in an attempt to determine a common theme, as described above.

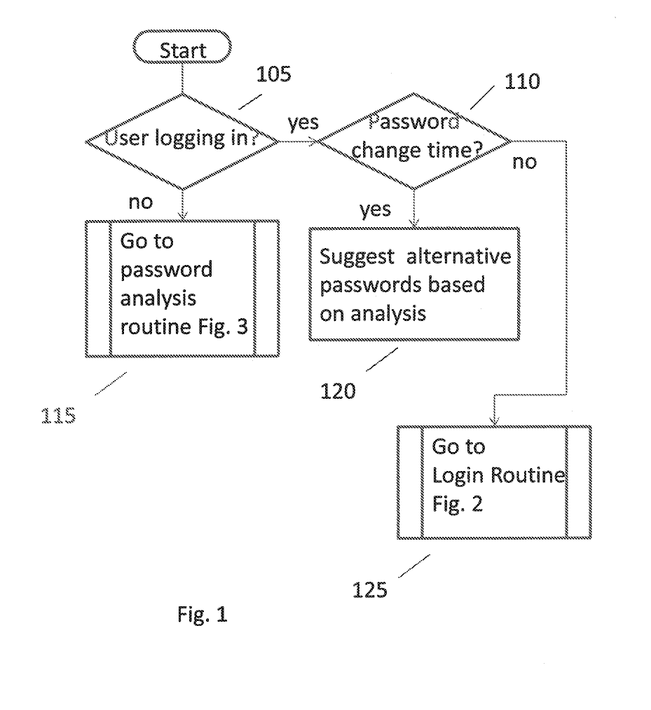

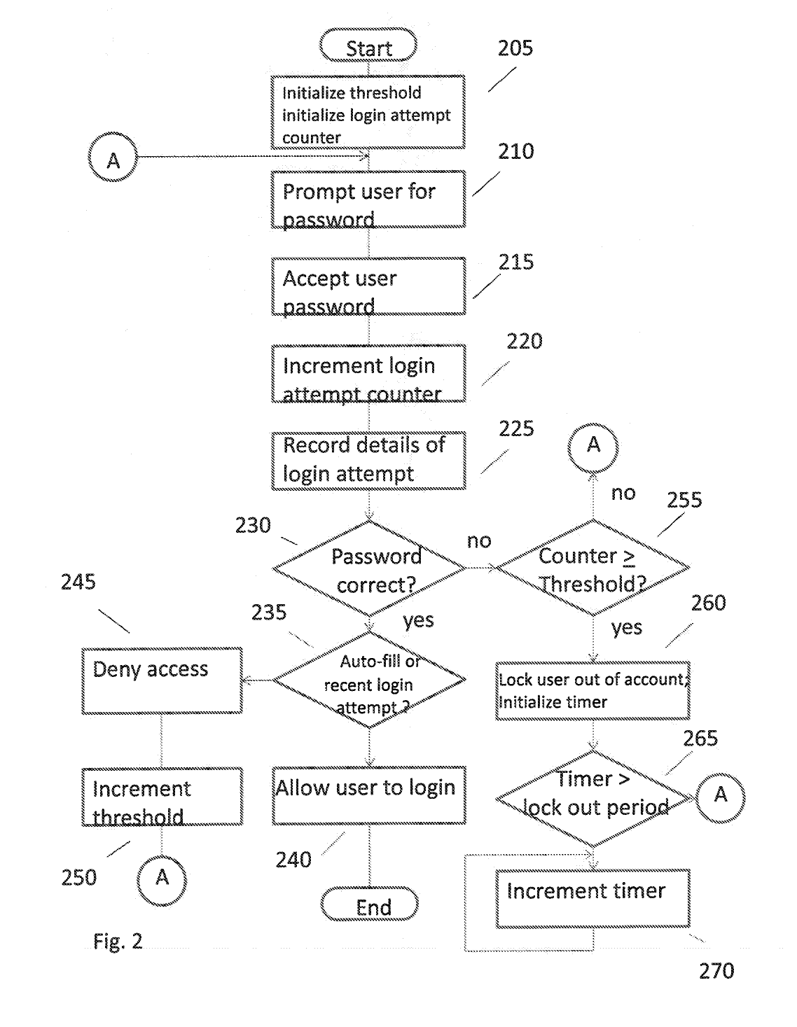

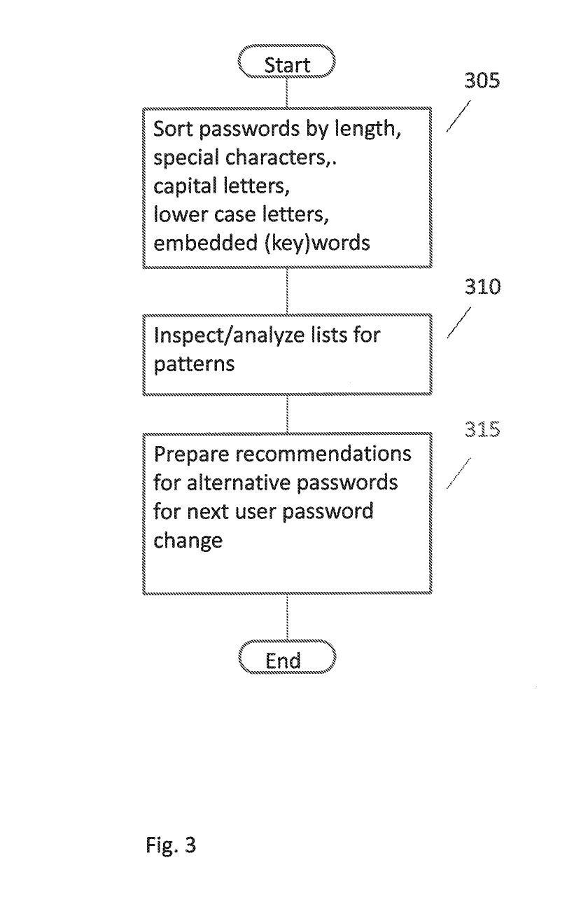

FIG. 1 is an overview flowchart of operation of a server in accordance with the principles of the present invention. At 105 the server determines if the user is attempting to login. If the user is attempting to login, then at 110 the server determines if it is time to change the password on the account. If it is not time to change the password on the account, then at 125 processing proceeds to the login routine shown in FIG. 2 and described below. If the user is not attempting to login, then at 125 during idle time the server, proceeds to the password analysis routine shown in FIG. 3 and described below. If it is time to change the password on the account, then at 120 the server suggests alternative passwords based on the analysis.

FIG. 2 is a flowchart of an exemplary login routine at the server in accordance with the principles of the present invention. At 205 the threshold and login attempt counter are initialized. At 210 the user is prompted to enter a password for the particular account that the user is attempting to access. At 215, the user's password entry is accepted. At 220, the login attempt counter is incremented. At 225, the details of the login attempt are recorded (stored). At 230, a test is performed to determine if the password entered is correct. If the password entered is correct then at 235 a test is performed to determine if there was a recent login attempt or if the password was entered by auto-filling a password pre-stored in the server. If there was a recent login attempt or if the password was entered by auto-filling a password pre-stored in the server then at 240 the user is permitted to login to the particular account that the user was attempting to access. If there was not a recent login attempt or if the password was not entered by auto-filling a password pre-stored in the server then at 245 the user is denied access to the particular account that the user was attempting to access. At 250 the threshold is incremented. Processing then proceeds to 210. If the password was not correct, then at 255 a test is performed to determine if the login attempt counter was greater than the threshold. If the login attempt counter is greater than the threshold then at 260 the user is locked out of the particular account that the user was attempting to access for a pre-determined period of time and a timer is initialized. At 265 a test is performed to determine if the timer is greater than the pre-determined lock out period of time. If the timer is greater than the pre-determined lock out period of time, then processing proceeds to 210. If the timer is less than the pre-determined lock out period of time, then at 270 the timer is incremented and processing proceeds to 265. If the login attempt counter is greater than the threshold, then processing proceeds to 210.

FIG. 3 is a flowchart of an exemplary password analysis routine at the server in accordance with the principles of the present invention. At 305, the server, sorts the passwords for the various accounts to which the server has access. This includes sorting the passwords by length, by special characters, by capital letters, by lower case letter, and by embedded keywords (words, recurring character strings). At 310 the server inspects and analyzes the lists to determine if there are any patterns. At 315 based on the analysis, the server prepares recommendations for alternative passwords for the user.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for enhanced login, said method comprising:
determining if a user is attempting to login to a particular account;
performing analysis on said user's passwords if the user is not attempting to login to said particular account, wherein said password analysis further comprises:
sorting said user's passwords into lists by multiple criteria wherein said multiple criteria include at least, length, special characters, capital letters, lower case letters, keywords and recurring character strings;
analyzing said lists for patterns; and
preparing recommendations for alternative passwords for changing said password;
determining if it is time to change a password on said particular account, if said user is attempting to login to said particular account;
suggesting alternative passwords to said user based on said password analysis; and
performing a login procedure.

2. (canceled)

3. (canceled)

4. The method according to claim 1, wherein said login procedure further comprises:
initializing a threshold;
initializing a login attempt counter;
prompting said user for said password for said particular account;
accepting said user's password for said particular account;
incrementing said login attempt counter;
recording details of said login attempt;
determining if said password for said particular account is correct;
determining if said password for said particular account was auto-filled or there was a recent login attempt, if said password for said particular account is correct;
allowing said user to login and access said particular account if both said third and said fourth determining acts are positive;
denying said user access to said particular account if said fourth determining act is negative;
incrementing said threshold;
determining if said login attempt counter is greater than said threshold, if said password for said particular account is not correct;
initializing a timer;
denying said user access to said particular account for a pre-determined period of time if said login attempt counter is greater than said threshold;
determining if said timer is greater than said pre-determined period of time; and
incrementing said timer if said timer is less than said pre-determined period of time.

5. A computer readable medium, having thereon instructions for directing a processor to:
determine if a user is attempting to login to a particular account;
perform analysis on said user's passwords if the user is not attempting to login to said particular account, wherein said password analysis further comprises:
sort said user's passwords into lists by multiple criteria wherein said multiple criteria include at least, length, special characters, capital letters, lower case letters, keywords and recurring character strings;
analyze said lists for patterns; and
prepare recommendations for alternative passwords for changing said password;
determine if it is time to change a password on said particular account, if said user is attempting to login to said particular account;
suggest alternative passwords to said user based on said password analysis; and
perform a login procedure.

6. The computer readable medium according to claim 5, wherein said login procedure further comprises:
initializing a threshold;
initializing a login attempt counter;
prompting said user for said password for said particular account;
accepting said user's password for said particular account;
incrementing said login attempt counter;
recording details of said login attempt;
determining if said password for said particular account is correct;
determining if said password for said particular account was auto-filled or there was a recent login attempt, if said password for said particular account is correct;
allowing said user to login and access said particular account if both said third and said fourth determining acts are positive;
denying said user access to said particular account if said fourth determining act is negative;
incrementing said threshold;
determining if said login attempt counter is greater than said threshold, if said password for said particular account is not correct;
initializing a timer;
denying said user access to said particular account for a pre-determined period of time if said login attempt counter is greater than said threshold;
determining if said timer is greater than said pre-determined period of time; and
incrementing said timer if said timer is less than said pre-determined period of time.
